(19) United States
(12) Patent Application Publication
(10) Pub. No.: US 2010/0161416 A1
(43) Pub. Date: Jun. 24, 2010

(54) METHOD OF PROVIDING TARGETED ADVERTISEMENTS

(75) Inventors: Euisok Chung, Daejeon (KR); Ji Hyun Wang, Daejeon (KR); Byung Ok Kang, Daejeon (KR); Jeon Gue Park, Daejeon (KR); Yunkeun Lee, Daejeon (KR); Hyo-Jung Oh, Daejeon (KR); Chang Ki Lee, Daejeon (KR); Chung Hee Lee, Daejeon (KR); Myung Gil Jang, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/491,788

(22) Filed: Jun. 25, 2009

(30) Foreign Application Priority Data
Dec. 22, 2008 (KR) 10-2008-0131242

(51) Int. Cl. G06Q 30/00; G06F 17/30

(52) U.S. Cl. 705/14.53; 707/E17.109

(57) ABSTRACT

A method of providing targeted advertisements, includes: generating an advertisement search result using a search query based on a user query or a recommended query; generating an advertisement search result on the basis of a user profile; integrating the advertisement search result generated on the basis of the user profile with the advertisement search result generated by using the search query; and presenting a recommended advertisement list on the basis of the integrated advertisement search result and advertisement information exposed to a user.

### CROSS-REFERENCE(S) TO RELATED APPLICATION(S)

The present invention claims priority of Korean Patent Application No. 10-2008-0131242, filed on Dec. 22, 2008, which is incorporated herein by reference.

### FIELD OF THE INVENTION

The present invention relates to a method for providing targeted advertisements; and, more particularly, to a method for providing targeted advertisements which is capable of providing users with optimally targeted advertisements through the integration of an individual-targeted advertising method using user information and a content-targeted advertising method suitable for broadcast content, in a broadcasting service environment.

### BACKGROUND OF THE INVENTION

As well known, in a broadcasting service such as IPTV (Internet Protocol Television), advertisements play a very important role in the acquisition of profits. Therefore, various methods of efficiently presenting advertisements to TV viewers have been proposed.

Conventional technologies for presenting advertisements in a broadcasting service will be described below.

As a conventional technology, there is a method of processing text information obtained from moving images and providing search results including advertising content consistent with the text information. That is, this method corresponds to a method of providing advertising contents consistent with contents of moving images. For example, in online advertising using the wired/wireless Internet, it is difficult to access personal information. Accordingly, users' intentions and preferences are indirectly understood by analyzing Internet news or specific contents selected by the user, and then content-targeted advertisements are provided to the users. However, this method has a problem that is not capable of providing individual-targeted advertisements in consideration of personal profiles.

As another conventional technology, there is a method of providing advertising contents suitable for a content requester on the basis of personal profile information. That is, this method corresponds to a method of providing a targeted advertisement service on the basis of an open interface. However, this method is not capable of providing content-targeted advertisements.

As described above, the conventional technologies for presenting advertisements which are applicable to an IPTV broadcasting service are problematic in that they do not take full advantages of the above-described individual-targeted advertising and content-targeted advertising because they present targeted advertisements on the basis of users' personal profiles or the traffic used by the users.

### SUMMARY OF THE INVENTION

In view of the above, the present invention provides a hybrid targeted advertisement presentation method of providing users with optimally targeted advertisements through the integration of an individual-targeted advertising method using user information and a content-targeted advertising method suitable for broadcast content in a broadcasting service environment such as IPTV. That is, the present invention provides a hybrid targeted advertisement presentation method of presenting advertisements to users through the integration of the two methods, including the targeted method for users' preferences appearing in user profiles and the targeted method based on the content selected by the users.

In accordance with a first aspect of the present invention, there is provided a method of providing targeted advertisements, including:

generating an advertisement search result using a search query based on a user query or a recommended query;

generating an advertisement search result on the basis of a user profile;

integrating the advertisement search result generated on the basis of the user profile with the advertisement search result generated by using the search query; and

presenting a recommended advertisement list on the basis of the integrated advertisement search result and advertisement information exposed to a user.

In accordance with a second aspect of the present invention, there is provided a method of providing targeted advertisements, including:

generating an advertisement search result using content meta information;

generating an advertisement search result on the basis of a user profile;

integrating the advertisement search result generated on the basis of the user profile with the advertisement search results generated by using the content meta information; and

presenting a recommended advertisement list on the basis of the integrated advertisement search result and advertisement information exposed to a user.

In accordance with a third aspect of the present invention, there is provided a method of providing targeted advertisements, including:

generating a content-targeted advertisement list using a real-time broadcast script in which a script acquired by closed caption decoding of content with a script acquired by voice recognition are integrated; and

reconfiguring the content-targeted advertisement list into a user-targeted advertisement recommendation list according to a user profile to present the reconfigured list.

In accordance with a fourth aspect of the present invention, there is provided a method of providing targeted advertisements, including:

generating an advertisement search result using real-time advertisement information;

generating an advertisement search result on the basis of a user profile;

integrating the advertisement search result generated by using the real-time advertisement information with the advertisement search result generated on the basis of the user profile; and

presenting a recommended advertisement list on the basis of the integrated advertisement search result and advertisement information exposed to a user.

### BRIEF DESCRIPTION OF THE DRAWINGS

The above features of the present invention will become apparent from the following description of embodiments given in conjunction with the accompanying drawings, in which:

FIGS. 1A and 1B show a configuration of a system for providing targeted advertisements in IPTV environment in accordance with an embodiment of the present invention;

FIG. 2 is a flowchart illustrating a process of providing a targeted advertisement in IPTV VOD service environment in accordance with the embodiment of the present invention;

FIG. 3 is a flowchart illustrating a process of providing targeted advertisements in IPTV real-time broadcasting environment and cable TV service environment in accordance with the embodiment of the present invention;

FIGS. 4A and 4B show a flowchart illustrating, in detail, a process of targeted advertisement server presenting an advertisement related to search query during the process of providing a targeted advertisement in IPTV VOD service environment in accordance with the embodiment of the present invention;

FIG. 5 is a diagram showing a process of expanding a query in accordance with the embodiment of the present invention;

FIG. 6 is a diagram showing a process of analyzing a user profile in accordance with the embodiment of the present invention;

FIGS. 7A, 7B and 7C are diagrams showing formats of advertisement meta information, content meta information and a user profile, respectively, in accordance with the embodiment of the present invention;

FIGS. 8A, 8B and 8C show a flowchart illustrating, in detail, a process of targeted advertisement server presenting an opening advertisement during the process of providing a targeted advertisement in IPTV VOD service environment in accordance with the embodiment of the present invention;

FIGS. 9A and 9B show a flowchart illustrating, in detail, a process of targeted advertisement server presenting real-time advertisements during the process of providing a targeted advertisement in IPTV VOD service environment in accordance with the embodiment of the present invention; and

FIG. 10 is a flowchart illustrating, in detail, a process of targeted advertisement server presenting an interim advertisement during the process of providing a targeted advertisement in IPTV VOD service environment in accordance with the embodiment of the present invention.

### DETAILED DESCRIPTION OF THE EMBODIMENTS

Exemplary embodiments of the present invention will be described in detail below with reference to the accompanying drawings. In the following description of the present invention, if it is determined that detailed descriptions of well-known functions or constructions may make the gist of the present invention unnecessarily unclear, the descriptions will be omitted.

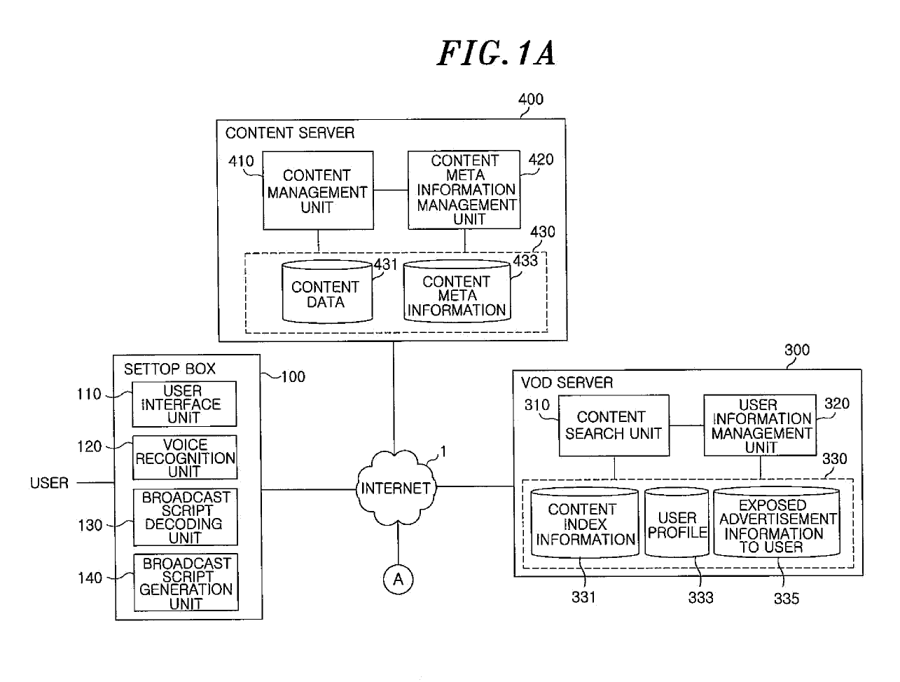

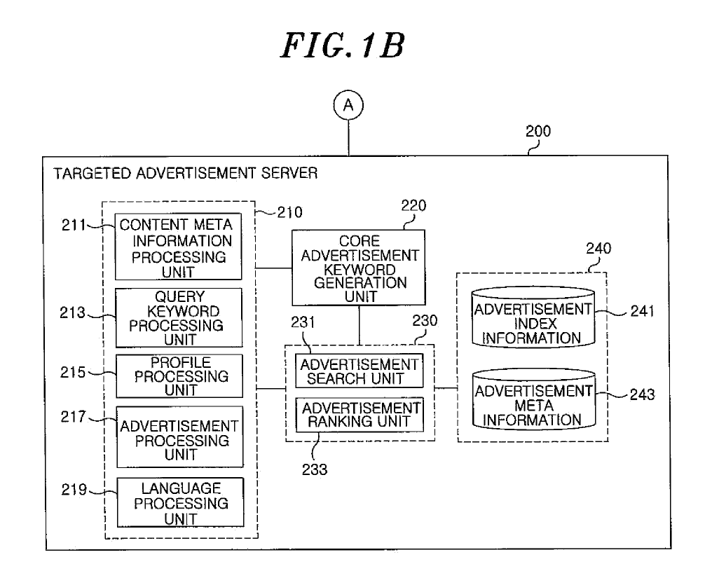

FIGS. 1A and 1B show a configuration of a system for providing targeted advertisements in IPTV environment in accordance with an embodiment of the present invention.

As shown in FIGS. 1A and 1B, the system for providing targeted advertisements includes a settop box 100, a targeted advertisement server 200, a VOD (Video On Demand) server 300 and a content server 400, which are connected to each other over a communication network such as Internet 1.

The settop box 100 includes a user interface unit 110, a voice recognition unit 120, a broadcast script decoding unit 130, and a broadcast script generation unit 140. The user interface unit 110 provides a content list retrieved by a content search query from a user, a content selected by the user and related advertising contents. The voice recognition unit 120 recognizes a voice of contents being played. The broadcast script decoding unit 130 decodes the closed caption of contents being played. The broadcast script generation unit 140 integrates a broadcast script extracted from the broadcast script decoding unit 130 with a broadcast script recognized by the voice recognition unit 120.

The targeted advertisement server 200 includes an input unit 210 for recommending advertisements, a core advertisement keyword generation unit 220 for generating a keyword to be used to search related advertisements in response to input contents, an advertisement recommendation unit 230 for searching and recommending advertisements, and an advertisement database unit 240 storing advertisement index information 241 and advertisement meta information 243.

The input unit 210 includes a content meta information processing unit 211, a query keyword processing unit 213, a profile processing unit 215, an advertisement information processing unit 217, and a language processing unit 219. Here, the content meta information processing unit 211 processes the attribute of broadcast contents, the query keyword processing unit 213 expands and processes a content search query of the user, and the profile processing unit 215 processes attribute information of the user provided thereto. The advertisement information processing unit 217 processes real-time advertisement meta information corresponding to a real-time recommended advertisement list for broadcast for the user. The language processing unit 219 processes a broadcast script acquired from contents.

The advertisement recommendation unit 230 includes an advertisement search unit 231 for searching the advertisement database unit 240 for a target advertisement based on a core advertisement keyword received from the core advertisement keyword generation unit 220 and an advertisement ranking unit 233 for deciding ranking of entries of a retrieved advertisement list in N-best form using various pieces of information.

The VOD server 300 includes a content search unit 310 for presenting a content list retrieved in response to the user's content search query to the user, a user information management unit 320 for managing a user profile 333 and exposed advertisement information 335 to a user, and a VOD database unit 330 for storing content index information 331, the user profile 333 and the exposed advertisement information 335.

The content server 400 includes a content management unit 410 for delivering contents when the user requests contents, a content meta information management unit 420 for managing content meta information 433 composed of profiles of the users who has accessed contents, and a content database unit 430 for storing content data 431 and the content meta information 433.

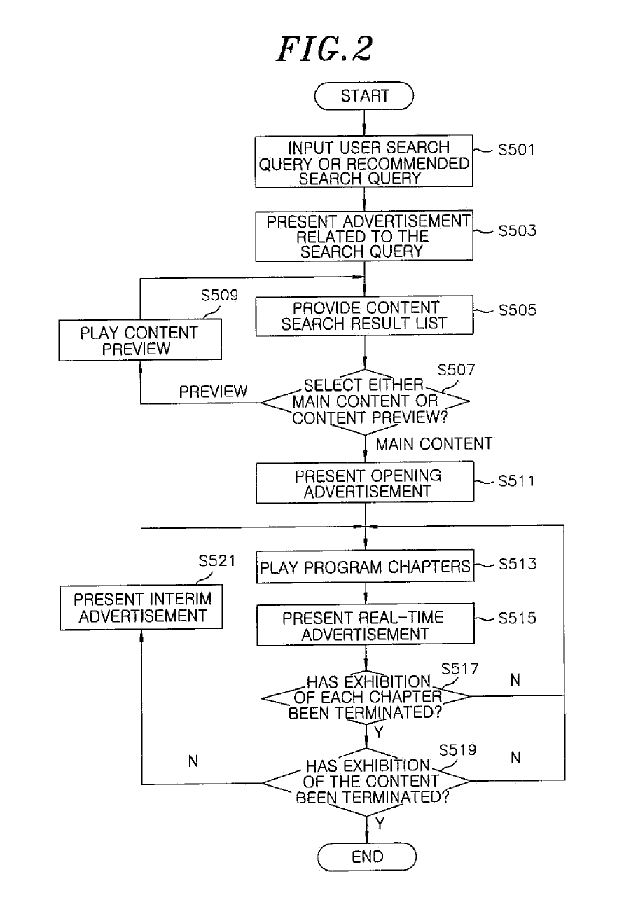

FIG. 2 is a flowchart illustrating a process of providing a targeted advertisement in IPTV VOD service environment in accordance with the embodiment of the present invention.

First, a user's content search query or a recommended search query is inputted to the user interface unit 110 of the settop box 100 in step S501. Next, the targeted advertisement server 200 presents an advertisement related to the content search query in step S503, and then the VOD server 300 provides a list of VOD content search results in step S505. The user needs to select either a main content or a content preview from the VOD content search result list through the user interface unit 110 in step S507. If the user selects the content preview, the content preview is played in step S509. Thereafter, the flow goes back to the step S505 so that the VOD server 300 provides the user with the VOD content search result list again. If the user selects the main content, the targeted advertisement server 200 presents an opening advertisement to the user under consideration of downloading the main content in step S511.

When the VOD server 300 plays program chapters of the selected content in step S513 after the opening advertisement has been presented, the targeted advertisement server 200 presents a real-time advertisement in step S515. Further, the targeted advertisement server 200 determines whether the exhibition of each chapter of the content has been terminated in step S517 and whether the exhibition of the content has been terminated in step S519. If it is determined that the exhibition of each chapter has been terminated when the exhibition of the content has not yet been terminated, the targeted advertisement server 200 presents an interim advertisement to the user in step S521 and returns to step S513 to play next program chapter.

If, however, it is determined that the exhibition of the content has been terminated, the VOD server 300 terminates the provision of the service or provides the VOD content search result list as in step S505 so that the user can select the exhibition of its preview or main content.

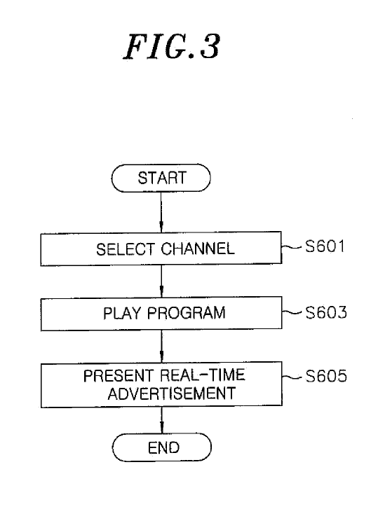

FIG. 3 is a flowchart illustrating a process of providing targeted advertisements in IPTV real-time broadcasting environment and cable TV service environment in accordance with the embodiment of the present invention. Here, real time refers to a moment when a broadcasting program is played by the content server 400 or a real-time broadcasting server.

Referring to FIG. 3, if a channel is selected in step S601, the settop box 100 plays a corresponding program in step S603 in response to the selection of a channel, and the targeted advertisement server 200 presents a real-time advertisement suitable for content of the program that is being played in step S605.

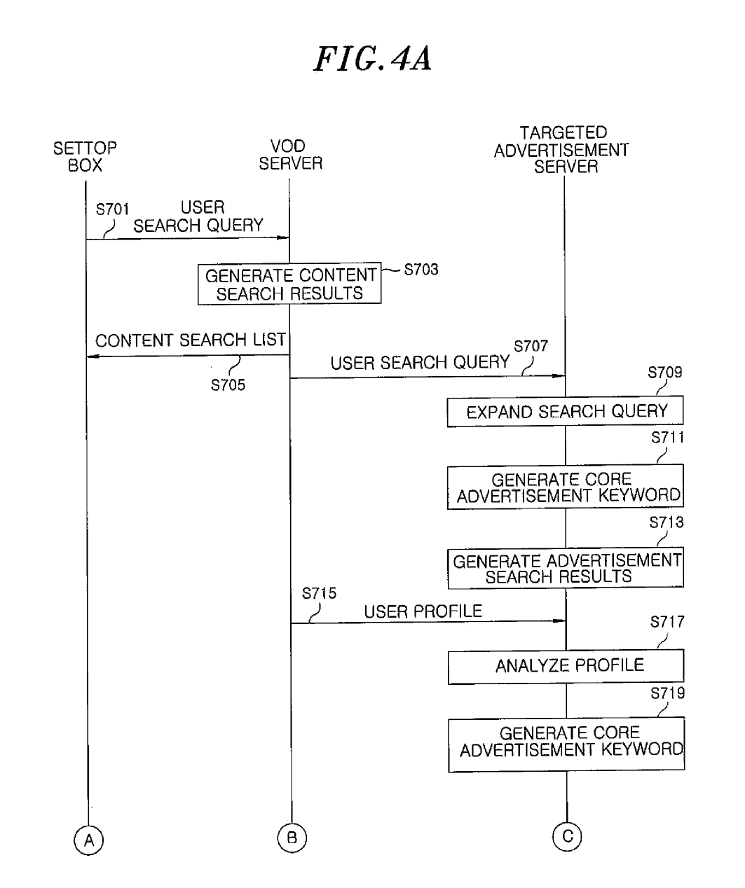

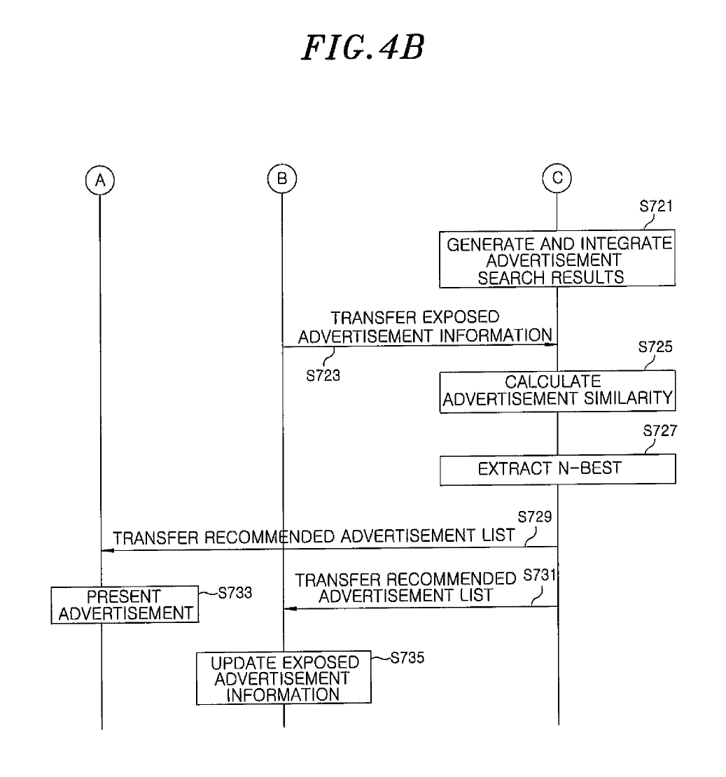

FIGS. 4A and 4B show a flowchart illustrating, in detail, a process of the targeted advertisement server 200 presenting an advertisement related to a search query during the process of providing a targeted advertisement in IPTV VOD service environment in accordance with the embodiment of the present invention.

First, the user interface unit 110 of the settop box 100 sends a user's content search query to the VOD server 300 in step S701. The content search unit 310 of the VOD server 300 generates a content search list on the basis of the results of searching for the content index information 331 of the VOD database unit 330 in step S703. The content search unit 310 returns the content search list to the settop box 100 in step S705, and sends the user's content search query to the targeted advertisement server 200 in step S707.

The query keyword processing unit 213 that expands the content search query in step S709. The core advertisement keyword generation unit 220 generates a core advertisement keyword in step S711.

Here, the query expansion step S709 is a procedure for finding an interim expression for generating the core advertisement keyword on the basis of the content search query. FIG. 5 is a diagram for describing the query expansion step. Referring to FIG. 5, this query expansion procedure includes receiving the user's content search query in step S801, searching a core advertisement keyword concept network in step S803 and then acquiring a similar concept list in step S805. The core advertisement keyword concept network 810 is previously constructed using concepts 811 and core advertisement keyword instances 813. Each of the concepts 811 has a description for describing a concept so as to enable keyword searching. The keyword searching includes a procedure of matching with the description. This drawing indicates that the concept 811 is described with a concept ID 821 and a keyword set 823 corresponding to the description.

The core advertisement keyword generation step S711 is a process of acquiring related core advertisement keyword instances 813 from a list of the concepts 811 of the core advertisement keyword concept network 810 derived from the query expansion step S709. Here, the generated core advertisement keyword is inputted to the advertisement search unit 231 of the advertisement recommendation unit 230. Thereafter, the advertisement search unit 231 generates advertisement search results in step S713.

After expanding the content search query, the targeted advertisement server 200 requests the VOD server 300 to provide the user profile 333. The user information management unit 320 of the VOD server 300 searches the VOD database unit 330 for the user profile 333 and provides the targeted advertisement server 200 with the user profile 333 in step S715.

The profile processing unit 215 of the targeted advertisement server 200 analyzes the user profile 333 in step S717. The core advertisement keyword generation unit 220 generates a core advertisement keyword on the basis of the results of the analysis of the user profile 333 in step S719, extracts a corresponding advertisement through the advertisement search unit 231, and then integrates the corresponding advertisement with the advertisement list through the content search query in step S721.

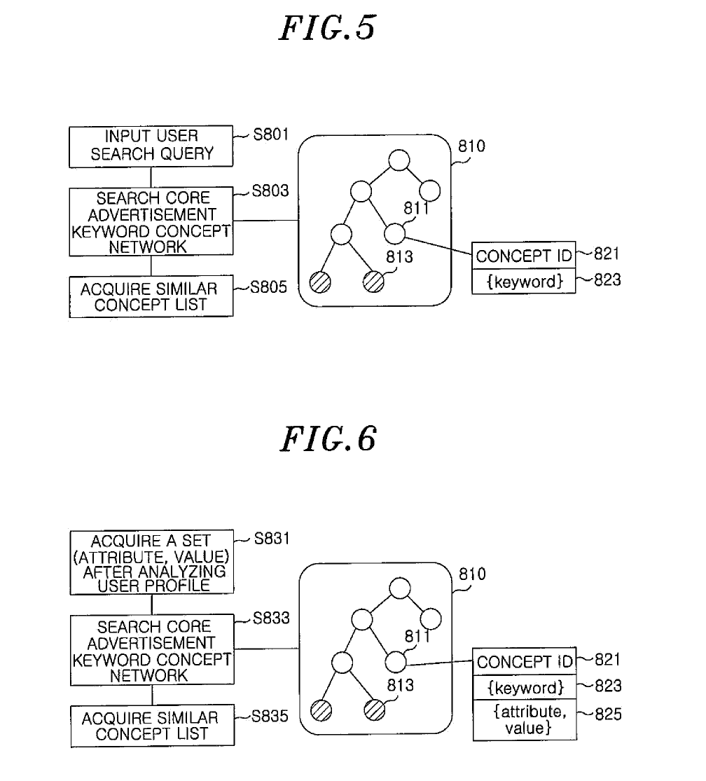

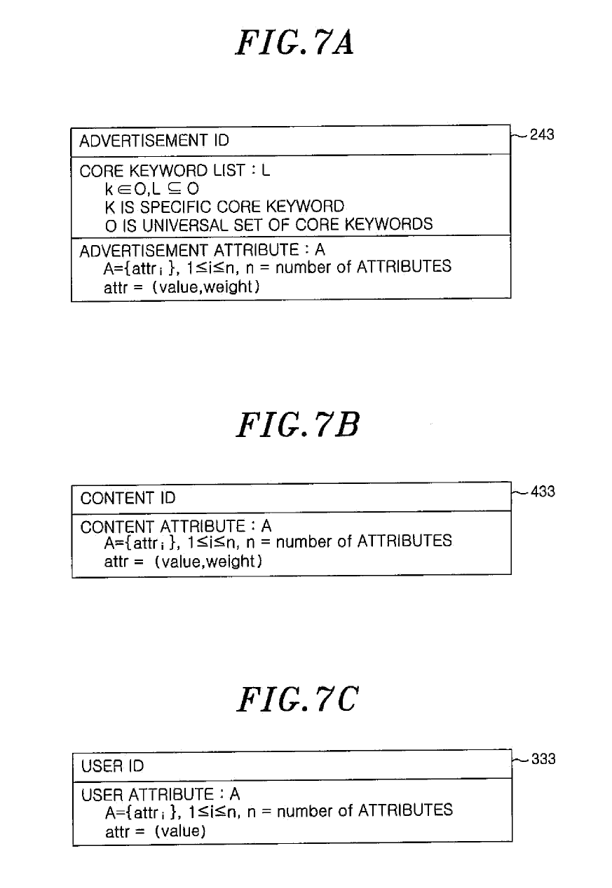

FIG. 6 is a diagram showing the process of analyzing the user profile in accordance with the embodiment of the present invention. First, the user profile 333 is analyzed, and then a set {attribute, value} is derived in step S831, wherein the user profile 333 includes a set of attributes and each of the attributes has a value, as shown in FIG. 7C. The core advertisement keyword concept network is searched in step S833, through the similar concept list is acquired in step S835. Here, the core advertisement keyword concept network 810 is previously constructed using concepts 811 and core advertisement keyword instances 813. Each of the concepts 811 is described using a concept ID 821, a keyword set 823 and a set {attribute, value} 825. The concept is used for the matching procedure of the search process.

Meanwhile, the advertisement search results acquired using the content search query and the user profile 333 may exist in the form of a plurality of advertisement lists. In the present invention, in order to recommend an optimal advertisement list suitable for a user from the advertisement lists, a ranking decided by calculating a similarity between the exposed advertisement information 335 of the VOD database unit 330 and the advertisement meta information 243 of the advertisement database unit 240 is used.

The exposed advertisement information 335 stored in the VOD database unit 330 keeps a list of upper k-number of advertisements by their exposed time, among advertisements recently exposed to the user, and may be simply considered to be a list of k-number of advertisement IDs.

Referring to FIG. 7A, the advertisement meta information 243 stored in the advertisement database unit 240 includes an advertisement attribute assigned based on the concept of the above core advertisement keyword. The advertisement attribute includes an attribute set which is composed of a pair of a value and weight of each attribute. The weight may be inferred from the upper concept of the core advertisement keyword, and, most simply, may be regarded as the frequency of the attribute value. Accordingly, the exposed advertisement information 335 may be considered to be k-pieces of advertisement meta information, and thus the ranking of the advertisement list derived from the process S721 of generating and integrating the advertisement search results can be determined by obtaining a centroid value of weights which make a pair with values in advertisement attribute set. More specifically, the advertisement ranking unit 233 receives the exposed advertisement information 335 from the VOD server 300 in step S723, calculates a similarity of the advertisements in step S725 and thereafter extracts N-best based on the similarity of the advertisements in step S727. Subsequently, a recommended advertisement list including a ranking in N-best form is transferred to the settop box 100 in step S729, and is then presented to the user in step S733. The recommended advertisement list is also transferred to the VOD server 300 in step S731 so that the exposed advertisement information 335 of the VOD database unit 330 is updated in step S735.

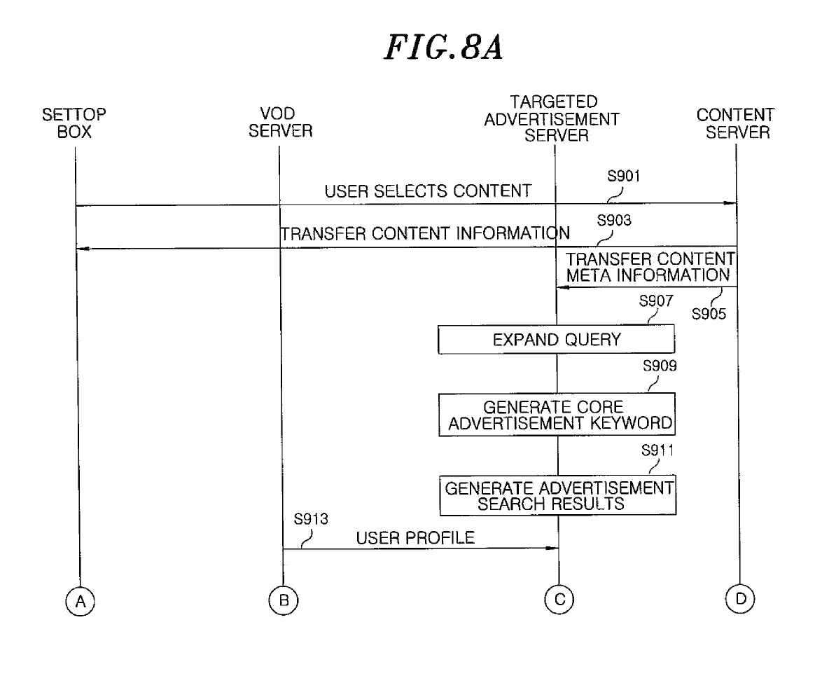

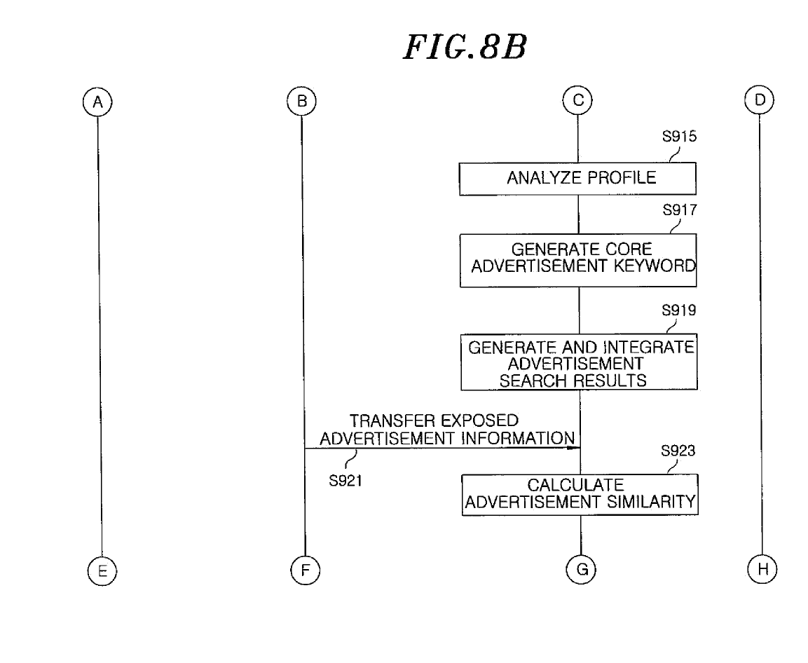

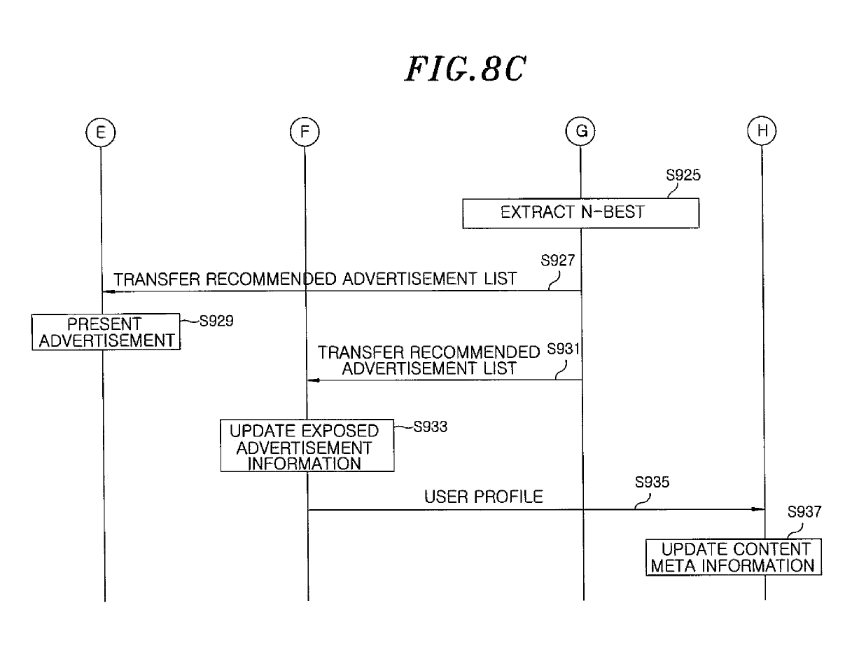

Hereinafter, a process of presenting an opening advertisement, a process of presenting a real-time advertisement and a process of presenting an interim advertisement will be described with reference to FIGS. 8A, 8B and 8C, 9A and 9B, and 10. In this regard, detailed descriptions of the same procedures as those of the process of presenting an advertisement related to a query shown in FIGS. 4A and 4B will be omitted.

FIGS. 8A, 8B and 8C show a flowchart illustrating, in detail, a process of targeted advertisement server 200 presenting an opening advertisement in accordance with the embodiment of the present invention. The opening advertisement refers to an advertisement which is presented while downloading content or prior to playing the content.

First, when the user selects content through the user interface unit 110 of the settop box 100 in step S901, the content server 400 sends information of the selected content to the settop box 100 in step S903, and then the content is downloaded from the content server 400 to the settop box 100. At this time, the content server 400 delivers the content meta information 433 to the targeted advertisement server 200 in step S905.

The content meta information 433 is described using a centroid value of the user profile 333 of the user who has selected the content, as shown in FIG. 7B. The content meta information 433 is analyzed in the content meta information processing unit 211 of the targeted advertisement server 200 in step S907, and is then transferred to the core advertisement keyword generation unit 220. Thereafter, the core advertisement keyword generation unit 220 generates a core advertisement keyword in step S909, and the advertisement recommendation unit 230 generates advertisement search results in step S911.

Next, the user profile 333 is transferred from the VOD server 300 to the targeted advertisement server 200 in step S913. After the user profile 333 has been analyzed in step S915 and a core advertisement keyword has been generated in step S917, advertisement search results are generated and integrated through the user profile 333 in step S919.

The exposed advertisement information 335 is passed from the VOD server 300 to the targeted advertisement server 200 in step S921. Based on the exposed advertisement information 335, a similarity of the advertisement is calculated in step S923 and N-best is extracted in step S925 so that a recommended advertisement list is transferred to the settop box 100 in step S927 and to the VOD server 300 in step S931. Then, the settop box 100 presents advertisements to the user in step S929 and the VOD server 300 updates the exposed advertisement information 335 in step S933. The user profile 333 is provided to the content server 400 in step S935, and then the content meta information 433 is updated in step S937.

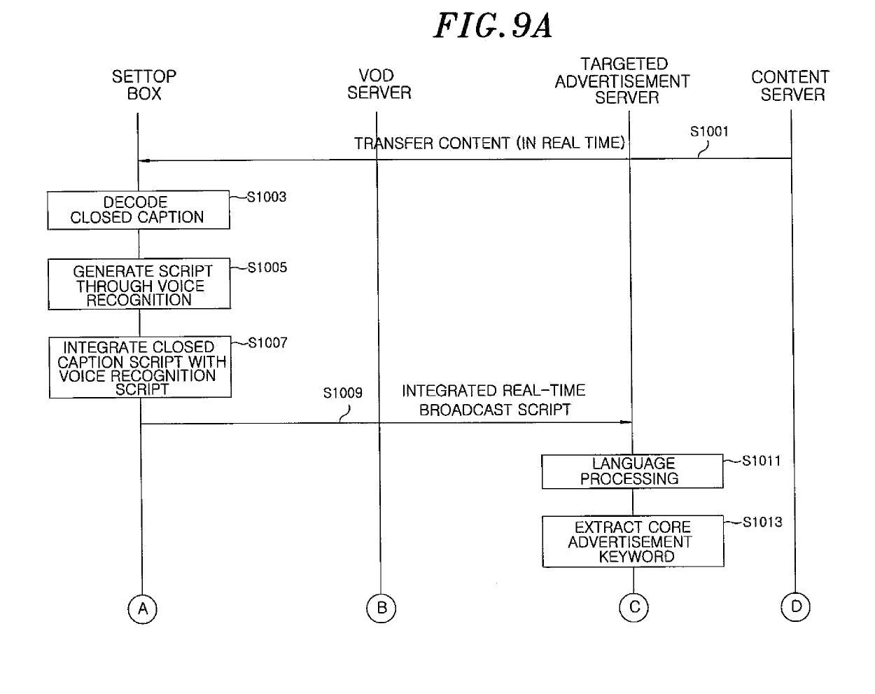

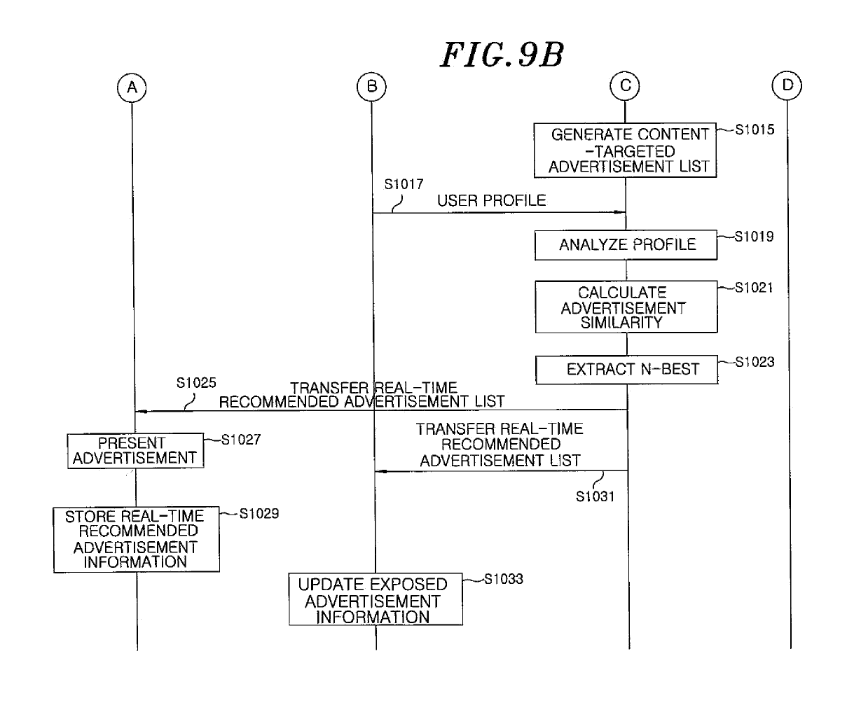

FIGS. 9A and 9B show a flowchart illustrating, in detail, a process of targeted advertisement server 200 presenting real-time advertisements in accordance with the embodiment of the present invention. This method of presenting real-time advertisements may be applied to not only VOD service of IPTV and a real-time broadcasting service but also the broadcasting service environment of a cable TV. In the present invention, in order to recommend content-targeted advertisements in real-time broadcasting environment, a broadcast script is generated to perform the recommendation of the advertisements. In order to recommend an individual-targeted advertisement, a user profile is used, and the recommended advertisements are filtered out so that they are suitable for the user.

First, during real-time broadcast in which content is delivered from the content server 400 to the settop box 100 in step S1001, the broadcast script decoding unit 130 of the settop box 100 generates a broadcast caption unit after performing a closed caption decoding which separates a script from information received from the content server 400 in step S1003. At the same time, the voice recognition unit 120 generates a script through voice recognition for the same amount of the content in step S1005. The broadcast script generation unit 140 integrates the respective scripts generated by the broadcast script decoding unit 130 and the voice recognition unit 120 in step S1007. Since both a script transmitted in real time and a script generated through voice recognition are inevitably incomplete, an approach using integration enables an improved broadcast script to be generated.

Thereafter, the integrated real-time broadcast script is transferred to the targeted advertisement server 200 in step S1009. The language processing unit 219 of the targeted advertisement server 200 performs a language processing which includes deriving a core advertisement keyword constituting a broadcast script in step S1011. Here, the core advertisement keyword is able to match a keyword list which consists of description information of a concept constituting the core advertisement keyword concept network 810. This language processing process results in a concept list. Thereafter, the core advertisement keyword is extracted in step S1013, and a list of content-targeted advertisements is generated, via the advertisement search unit 231, in step S1015.

The user profile 333 is transferred from the VOD server 300 to the targeted advertisement server 200 in step S1017. The content-targeted advertisement list is reconfigured into a user-targeted advertisement recommendation list through a process of analyzing the user profile 333 in step S1019, a process of calculating advertisement similarity in step S1021 and a process of extracting N-best in step S1023. This process is a core element of the hybrid targeted advertisement providing method which integrates the content-targeted advertisement with the individual-targeted advertisement. The method of calculating the advertisement similarity through the analysis of the user profile 333 is the same as the above similarity calculation method because both methods are based on a user attribute set.

The user-targeted advertisement recommendation list recommended as described above, i.e. a real-time recommended advertisement list is passed to the settop box 100 in step S1025, and advertisements are then presented to the user in step S1027. The settop box 100 stores the received real-time recommended advertisement list on a content-chapter basis in step S1029 so that the list can be used in a process of presenting interim advertisements to be described later. The real-time recommended advertisement list is also transferred from the targeted advertisement server 200 to the VOD server 300 in step S1031. The VOD server 300 updates the exposed advertisement information 335 of the VOD database unit 330 in step S1033.

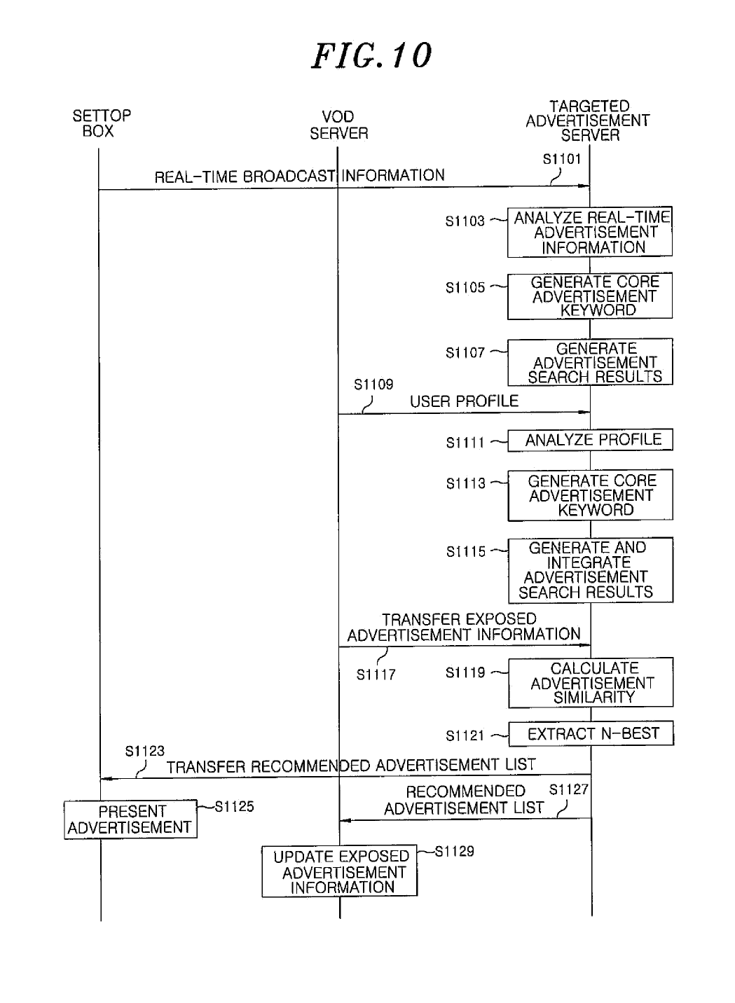

FIG. 10 is a flowchart illustrating, in detail, a process of targeted advertisement server 200 presenting interim advertisements in accordance with the embodiment of the present invention.

An attempt to recommend interim advertisements is made using a real-time recommended advertisement list which is transferred to the user while a real-time advertisement being presented. When one chapter of content is terminated, information about real-time recommended advertisements transferred during the chapter is delivered to the targeted advertisement server 200 in step S1101. Thereafter, the real-time advertisement information is analyzed in step S1103 and a core advertisement keyword is generated in step S1105, thereby generating advertisement search results in step S1107.

Next, the user profile 333 is sent from the VOD server 300 to the targeted advertisement server 200 in step S1109 and the user profile 333 is analyzed in step S1111. A core advertisement keyword is generated based on the user profile 333 in step S1113, and advertisement search results are generated and integrated in step S1115.

When the exposed advertisement information 335 is delivered to from the VOD server 300 to the targeted advertisement server 200 in step S1117, using the exposed advertisement information 335 a final recommended advertisement list for interim advertising is generated through a process of calculating advertisement similarity in step S1119 and a process of extracting N-best in step S1121.

The recommended advertisement list for interim advertising is transferred to the settop box 100 in step S1123, and advertisements are then presented to the user in step S1125. The recommended advertisement list for interim advertising is also transferred to the VOD server 300 in step S1127 and the exposed advertisement information 335 is updated in step S1129.

According to the present invention, a hybrid targeted advertisement is provided to a user through the integration of an individual-based targeted advertising method using user information and a content-targeted advertising method suitable for broadcast content in broadcasting service environment. Accordingly, advertisements suitable for the users' preferences can be presented to the user in the broadcasting service environment. In particular, when the present invention is applied to IPTV broadcasting service environment, there are advantages in that advertisements suitable for the IPTV users' preferences can be presented to the users and advertisements suitable for the users can be presented to the user at various points in time.

Up to now, the hybrid targeted advertisement presentation method in accordance with the present invention has been described according to points in time at which advertisements are presented. It has been assumed that the user profile 333, which is the basis of the present invention, is received from the user and is not changed. Furthermore, it is assumed that the advertisement meta information 243 and the content meta information 433 are constructed on the basis of the user profile information. Moreover, it has been assumed that the core advertisement keyword concept network 810 has already been constructed according to a proposed format.

The method of providing targeted advertisements in accordance with the present invention may be implemented using a computer program. Codes and code segments constituting the computer program may be easily inferred by computer programmers skilled in the art. Furthermore, the corresponding computer program may be stored in a computer readable medium and may be read and executed by a computer, thereby implementing the method of providing targeted advertisements. The computer readable medium may include a magnetic recording medium, an optical recording medium, and a carrier wave medium.

While the invention has been shown and described with respect to the embodiments, it will be understood by those skilled in the art that various changes and modifications may be made without departing from the scope of the invention as defined in the following claims.

What is claimed is:

1. A method of providing targeted advertisements, comprising:
generating an advertisement search result using a search query based on a user query or a recommended query;
generating an advertisement search result on the basis of a user profile;
integrating the advertisement search result generated on the basis of the user profile with the advertisement search result generated by using the search query; and
presenting a recommended advertisement list on the basis of the integrated advertisement search result and advertisement information exposed to a user.

2. The method of claim 1, wherein said generating the advertisement search result using the search query includes:
finding an interim expression for generating a core advertisement keyword on the basis of the search query;
creating the core advertisement keyword on the basis of the interim expression; and
generating the advertisement search result on the basis of the core advertisement keyword.

3. The method of claim 2, wherein said finding the interim expression includes deriving a similar concept list after searching a core advertisement keyword concept network using the search query.

4. The method of claim 3, wherein said generating the core advertisement keyword includes deriving related core advertisement keyword instances from the similar concept list.

5. The method of claim 1, wherein said generating the advertisement search result on the basis of the user profile includes:
creating a core advertisement keyword on the basis of analysis results of the user profile; and
generating the advertisement search result on the basis of the core advertisement keyword.

6. The method of claim 1, wherein said presenting the recommended advertisement list includes:
deciding ranking, in N-best form, of entries of an advertisement list acquired from the integrated advertisement search result, using the exposed advertisement information; and
presenting the recommended advertisement list including the ranking of N-best form.

7. A method of providing targeted advertisements, comprising:
generating an advertisement search result using content meta information;
generating an advertisement search result on the basis of a user profile;
integrating the advertisement search result generated on the basis of the user profile with the advertisement search results generated by using the content meta information; and
presenting a recommended advertisement list on the basis of the integrated advertisement search result and advertisement information exposed to a user.

8. The method of claim 7, wherein said generating the advertisement search result using content meta information includes:
analyzing the content meta information described using a centroid value of the user profile;
creating a core advertisement keyword on the basis of analysis results of the content meta information; and
generating the advertisement search results on the basis of the core advertisement keyword.

9. The method of claim 7, wherein said generating the advertisement search result on the basis of the user profile includes:
creating a core advertisement keyword on the basis of analysis results of the user profile; and
generating the advertisement search result on the basis of the core advertisement keyword.

10. The method of claim 7, wherein said presenting the recommended advertisement list includes:
deciding ranking, in N-best form, of entries of an advertisement list acquired from the integrated advertisement search result, using the exposed advertisement information; and
presenting the recommended advertisement list including the ranking of N-best.

11. A method of providing targeted advertisements, comprising:
generating a content-targeted advertisement list using a real-time broadcast script in which a script acquired by closed caption decoding of content with a script acquired by voice recognition are integrated; and
reconfiguring the content-targeted advertisement list into a user-targeted advertisement recommendation list according to a user profile to present the reconfigured list.

12. The method of claim 11, wherein said generating the content-targeted advertisement list includes:
deriving a concept list through language processing on the integrated real-time broadcast script;
extracting a core advertisement keyword from the concept list; and
generating the content-targeted advertisement list on the basis of the core advertisement keyword.

13. The method of claim 11, wherein said reconfiguring the content-targeted advertisement list into a user-targeted advertisement recommendation list includes:
deciding ranking, in N-best form, of entries of the content-targeted advertisement list using the user profile; and
reconfiguring the content-targeted advertisement list into the user-targeted advertisement recommendation list including the ranking of N-best form to present the reconfigured list.

14. A method of providing targeted advertisements, comprising:
generating an advertisement search result using real-time advertisement information;
generating an advertisement search result on the basis of a user profile;
integrating the advertisement search result generated by using the real-time advertisement information with the advertisement search result generated on the basis of the user profile; and
presenting a recommended advertisement list on the basis of the integrated advertisement search result and advertisement information exposed to a user.

15. The method of claim 14, wherein said generating the advertisement search result includes:
analyzing the real-time advertisement information;
creating a core advertisement keyword on the basis of the analysis results of the real-time advertisement information; and
generating the advertisement search result on the basis of the core advertisement keyword.

16. The method of claim 14, wherein said generating the advertisement search result on the basis of the user profile includes:
creating a core advertisement keyword on the basis of results of analysis of the user profile; and
generating the advertisement search result on the basis of the core advertisement keyword.

17. The method of claim 14, wherein said presenting the recommended advertisement list includes:
deciding ranking, in N-best form, of entries of an advertisement list acquired on the basis of the integrated advertisement search result, using the exposed advertisement information; and
presenting the recommended advertisement list including the ranking of N-best form.
